(19) United States
(12) Patent Application Publication
(10) Pub. No.: US 2026/0026501 A1
(43) Pub. Date: Jan. 29, 2026

(54) AGROCHEMICAL COMPOSITION OF SDHI FUNGICIDES

(71) Applicant: ADAMA MAKHTESHIM LTD., Beer Sheva (IL)

(72) Inventors: Jenny LERNER YARDENI, Mishmar Hanegev (IL); Viacheslav FIRER SLAVA, Beer-Sheva (IL); Hanan SERTCHOOK, Gedera (IL)

(73) Assignee: ADAMA MAKHTESHIM LTD., Beer Sheva (IL)

(21) Appl. No.: 18/993,939

(22) PCT Filed: Jul. 10, 2023
(86) PCT No.: PCT/IL2023/050714

§ 371 Date: Jan. 13, 2025

Related U.S. Application Data
(60) Provisional application No. 63/388,655, filed on Jul. 13, 2022.

(51) Int. Cl. A01N 43/56; A01N 25/02; A01P 3/00

(52) U.S. Cl. CPC A01N 43/56; A01N 25/02; A01P 3/00

(57) ABSTRACT

An agrochemical emulsion concentrate composition comprising at least one SDHI fungicide, a carbonyl containing solvent and an adjuvant of formula (I) CxHy(EO)z-OH in which X is 6-13, Y is 14-28, and Z is 3-13.

### TECHNICAL FIELD OF THE INVENTION

The present invention relates to novel compositions of SDHI fungicides for controlling plant diseases and to a method for controlling plant diseases which demonstrates enhanced control efficacy.

### BACKGROUND OF THE INVENTION

The succinate dehydrogenase inhibitor (SDHI) fungicide class is the fastest growing in terms of new compounds produced and launched into the fungicide market in agriculture.

The SDH enzyme (also termed succinate ubiquinone oxidoreductase) is a mitochondrial heterotetramer composed of four nuclear-encoded subunits. In contrast to other dehydrogenases of the tricarboxylic acid (TCA) cycle, the SDH enzyme transfers succinate-derived electrons directly to the ubiquinone pool of the respiratory chain and not to soluble nicotinamide adenine dinucleotide (NAD+) intermediates. For this reason, SDH, named also complex II, is considered to be an essential component of the respiratory chain. All crop protection SDHI target the ubiquinone-binding pocket. Upon binding, they physically block the access to the substrate, which consequently prevents further cycling of succinate oxidation.

Some of the commonly used SDHI fungicides are fluopyram, fluxapyroxad, bixafen and boscalid.

There is an ongoing need to develop effective fungicidal compositions, which exhibit desired characteristics, including good emulsion stability having spontaneous emulsification upon dilution without crystallization problems.

In emulsion concentrate compositions, crystal growth of the active ingredient can occur during the addition of water especially while using polar aprotic solvents.

It is known that it is difficult to prepare stable SDHI formulations due to rapid crystallization of the active.

The inventors have surprisingly found that the combination of a carbonyl containing solvent and certain adjuvants of formula (I) can achieve good emulsion stability and minimize crystal growth of the SDHI fungicide in the composition.

### TECHNICAL FIELD OF THE INVENTION

The present invention relates to novel compositions of SDHI fungicides for controlling plant diseases and a method for controlling plant diseases which possesses excellent control efficacy.

### SUMMARY

The present invention therefore provides an agrochemical emulsion concentrate composition comprising:
a) at least one SDHI fungicide;
b) a carbonyl containing solvent;
c) an adjuvant of formula (I)

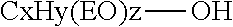

in which X is 6-13, Y is 14-28, and Z is 3-13.

In yet other embodiments, the present invention is directed to the use of a combination of a carbonyl containing solvent and adjuvant of formula (I)

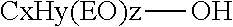

in which X is 6-13, Y is 14-28, and Z is 3-13 for increasing the efficacy of SDHI fungicides.

In a further embodiment, the present invention is directed to a combination of a carbonyl containing solvent and adjuvant of formula (I)

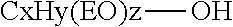

in which X is 6-13, Y is 14-28, and Z is 3-13 for increasing the efficacy of SDHI fungicides.

In a further embodiment, the present invention is directed to a method of control of crystal growth of SDHI fungicide in agrochemical emulsion by addition of a) carbonyl containing solvent, b) N-alkyl pyrrolidone of formula (II):

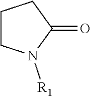

wherein R1 is a straight or branched, saturated or unsaturated, substituted or unsubstituted hydrocarbon group having from 4 to 10 carbon atoms and c) adjuvant of formula (I)

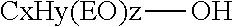

in which X is 6-13, Y is 14-28 and Z is 3-13.

### DETAILED DESCRIPTION OF THE PREFERRED EMBODIMENTS

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

As used herein the term “adjuvant of formula (I)” refers to the adjuvant of formula (I) in which X is 6-13, Y is 14-28, and Z is 3-13.

As used herein the term “N-alkyl pyrrolidone of formula (II)” refers to the N-alkyl pyrrolidone of formula (II) wherein R1 is a straight or branched, saturated or unsaturated, substituted or unsubstituted hydrocarbon group having from 4 to 10 carbon atoms.

As used herein the term “r.t” or “room temperature” is about 25±5° C.

The present invention provides an agrochemical emulsion concentrate composition comprising:
a) at least one SDHI fungicide;
b) a carbonyl containing solvent;
c) an adjuvant of formula (I)

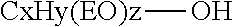

in which X is 6-13, Y is 14-28, and Z is 3-13.

In some embodiments, the at least one SDHI fungicide is selected from the group consisting of benodanil, flutolanil, mepronil, isofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, pydiflumetofen, pyraziflumid and any combination thereof. In some embodiments, the at least one SDHI fungicide is fluxapyroxad.

In some embodiments, the carbonyl containing solvent is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctenone (30), 2,4,6-cycloheptatrien-1-one, acetophenone, propiophenone (19), 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In some embodiments, the ketone is cyclohexanone, acetophenone, heptanone and any mixtures thereof. In an embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In some embodiments, the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, the adjuvant of formula (I) in which X is 13, Y is 27, and Z is between 7 to 15.

In some embodiments, the amount of the at least one SDHI fungicide is of about 1% to about 20% by weight, based on the total weight of the composition. In some embodiments, the amount of the at least one SDHI fungicide is of about 1% to about 15% by weight, based on the total weight of the composition. In some embodiments, the amount of the at least one SDHI fungicide is of about 7% by weight, based on the total weight of the composition.

In some embodiments, the amount of fluxapyroxad is of about 1% to about 20% by weight, based on the total weight of the composition. In some embodiments, the amount of fluxapyroxad is of about 1% to about 15% by weight, based on the total weight of the composition. In some embodiments, the amount of fluxapyroxad is of about 7% by weight, based on the total weight of the composition.

In some embodiments, the at least one SDHI fungicide is in a concentration ranging from about 10 g/l to about 220 g/l of the composition. In some embodiments, the at least one SDHI fungicide is in a concentration ranging from about 50 g/l to about 150 g/l of the composition. In some embodiments, the at least one SDHI fungicide is in a concentration of about 75 g/l of the composition.

In some embodiments, fluxapyroxad is in a concentration ranging from about 10 g/l to about 220 g/l of the composition. In some embodiments, fluxapyroxad is in a concentration ranging from about 50 g/l to about 150 g/l of the composition. In some embodiments, fluxapyroxad is in a concentration of about 75 g/l of the composition.

In some embodiments, the amount of the carbonyl containing solvent is of about 10% to about 60% by weight, based on the total weight of the composition. In some embodiments, the amount of the carbonyl containing solvent is of about 20% to about 50% by weight, based on the total weight of the composition. In some embodiments, the amount of the carbonyl containing solvent is of about 40% by weight, based on the total weight of the composition.

In some embodiments, the amount of acetophenone is of about 10% to about 60% by weight, based on the total weight of the composition. In some embodiments, the amount of acetophenone is of about 20% to about 50% by weight, based on the total weight of the composition. In some embodiments, the amount of acetophenone is of about 40% by weight, based on the total weight of the composition.

In some embodiments, the amount of adjuvant of formula (I) is of about 1% to about 20% by weight, based on the total weight of the composition. In some embodiments, the amount of adjuvant of formula (I) is of about 3% to about 15% by weight, based on the total weight of the composition. In some embodiments, the amount of adjuvant of formula (I) is of about 11% by weight, based on the total weight of the composition.

In some embodiments, the amount of adjuvant of formula (I) in which X is 13, Y is 27, and Z is between 7 to 15 is of about 1% to about 20% by weight, based on the total weight of the composition. In some embodiments, the amount of adjuvant of formula (I) in which X is 13, Y is 27, and Z is between 7 to 15 is of about 3% to about 15% by weight, based on the total weight of the composition. In some embodiments, the amount of adjuvant of formula (I) in which X is 13, Y is 27, and Z is between 7 to 15 is of about 11% by weight, based on the total weight of the composition.

In some embodiments, the ratio between the carbonyl containing solvent and the adjuvant of formula (I) is of about 60:1 to about 1:2. In some embodiments, the ratio between the carbonyl containing solvent and the adjuvant of formula (I) is of about 10:3 to about 4:3. In some embodiments, the ratio between the carbonyl containing solvent and the adjuvant of formula (I) is of about 3.5.

In some embodiments, the ratio between acetophenone and the adjuvant of formula (I) is of about 60:1 to about 1:2. In some embodiments, the ratio between acetophenone and the adjuvant of formula (I) is of about 10:3 to about 4:3. In some embodiments, the ratio between acetophenone and the adjuvant of formula (I) is of about 3.5.

In some embodiments, the ratio between acetophenone and the adjuvant of formula (I) in which X is 13, Y is 27, and Z is between 7-15 is of about 60:1 to about 1:2. In some embodiments, the ratio between acetophenone and the adjuvant of formula (I) in which X is 13, Y is 27, and Z is between 7-15 is of about 10:3 to about 4:3. In some embodiments, the ratio between acetophenone and the adjuvant of formula (I) in which X is 13, Y is 27, and Z is between 7-15 is of about 3.5.

In some embodiments, the agrochemical emulsion concentrate composition further comprises d) a triazole fungicide and e) N-alkyl pyrrolidone of formula (11):

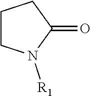

wherein R1 is a straight or branched, saturated or unsaturated, substituted or unsubstituted hydrocarbon group having from 4 to 10 carbon atoms.

In some embodiments, the triazole fungicide is selected from the group consisting of azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof. In some embodiments, the triazole fungicide is prothioconazole.

In some embodiments, in formula (II) R1 is a hydrocarbon group having from 7 to 9 carbon atoms. In some embodiments, in formula (II) R1 is a hydrocarbon group having 8 carbon atoms.

In some embodiments, the N-alkyl pyrrolidone of formula (II) is 1-octyl-2-pyrrolidone.

In some embodiments, the amount of the N-alkyl pyrrolidone of formula (II) is of about 2% to about 50% by weight, based on the total weight of the composition. In some embodiments, the amount of the N-alkyl pyrrolidone of formula (II) is of about 2% to about 30% by weight, based on the total weight of the composition. In some embodiments, the amount of the N-alkyl pyrrolidone of formula (II) is of about 16% weight, based on the total weight of the composition.

In some embodiments, the amount of 1-octyl-2-pyrrolidone is of about 2% to about 50% by weight, based on the total weight of the composition. In some embodiments, the amount of 1-octyl-2-pyrrolidone is of about 2% to about 30% by weight, based on the total weight of the composition. In some embodiments, the amount of 1-octyl-2-pyrrolidone is of about 16% weight, based on the total weight of the composition.

In some embodiments, the ratio between the carbonyl containing solvent and the N-alkyl pyrrolidone of formula (II) is of about 30:1 to about 1:5. In some embodiments, the ratio between the carbonyl containing solvent and the N-alkyl pyrrolidone of formula (II) is of about 25:1 to about 2:3. In some embodiments, the ratio between the carbonyl containing solvent and the N-alkyl pyrrolidone of formula (II) is of about 3:1. In some embodiments, the ratio between the carbonyl containing solvent and the N-alkyl pyrrolidone of formula (II) is of about 2.5:1.

In some embodiments, the ratio between acetophenone and the N-alkyl pyrrolidone of formula (II) is of about 30:1 to about 1:5. In some embodiments, the ratio between acetophenone and the N-alkyl pyrrolidone of formula (II) is of about 25:1 to about 2:3. In some embodiments, the ratio between acetophenone and the N-alkyl pyrrolidone of formula (II) is of about 3:1. In some embodiments, the ratio between acetophenone and the N-alkyl pyrrolidone of formula (II) is of about 2.5:1.

In some embodiments, the ratio between acetophenone and 1-octyl-2-pyrrolidone is of about 30:1 to about 1:5. In some embodiments, the ratio between acetophenone and 1-octyl-2-pyrrolidone is of about 25:1 to about 2:3. In some embodiments, the ratio between acetophenone and 1-octyl-2-pyrrolidone is of about 3:1. In some embodiments, the ratio between acetophenone and 1-octyl-2-pyrrolidone is of about 2.5:1.

In some embodiments, the amount of the triazole fungicide is of about 0.5% to about 25% by weight, based on the total weight of the composition. In some embodiments, the amount of the triazole fungicide is of about 4.5% to about 18.5% by weight, based on the total weight of the composition.

In some embodiments, the amount of the triazole fungicide is of about 14% by weight, based on the total weight of the composition.

In some embodiments, the amount of prothioconazole is of about 0.5% to about 25% by weight, based on the total weight of the composition. In some embodiments, the amount of prothioconazole is of about 4.5% to about 18.5% by weight, based on the total weight of the composition. In some embodiments, the amount of prothioconazole is of about 14% by weight, based on the total weight of the composition.

In some embodiments, the agrochemical emulsion concentrate composition further comprises at least one mono-, di- or tristyryl phenol ethoxylate and any combination thereof.

The at least one mono-, di- or tristyryl phenol ethoxylate can be anionic or non-ionic. Non limiting examples of the mono-, di- or tristyryl phenol ethoxylate are Soprophor® 3D33, Soprophor® BSU, Soprophor® 796/P, Soprophor® CY/8, Soprophor® S/25, Soprophor® TS/29, Soprophor® TS/54, Soprophor® 4D384, Soprophor® FL, Soprophor® FLK, Lucramul® PS 10, Emulsogen® TS 100, Emulson® AG 7710A, Termul® 3130, Lucramul® PS 16, LUCRAMUL® PS 20, Lucramul® PS 25, Lucramul® PS 29, Lucramul® PS 54, Emulsogen® TS 160, Emulsogen® TS 200, Emulsogen® TS 290, Emulsogen® TS 540, Emulsogen® TS 600, Termul® 3150, Termul® 3162, Termul® 3170, Termul® 3180, Termul® 3195, Tersperse® 2218, Tersperse® 2201, Tersperse® 2202, Tersperse® 2203 and Tersperse® 2222.

In some embodiments, the amount of the at least one mono-, di- or tristyryl phenol ethoxylate is of about 0.5% to about 20% by weight, based on the total weight of the composition.

In some embodiments, the amount of the at least one tristyryl phenol ethoxylate is of about 0.5% to about 20% by weight, based on the total weight of the composition.

In some embodiments, the agrochemical emulsion concentrate composition comprises at least one non-ionic mono-, di- or tristyryl phenol ethoxylate and/or at least one anionic mono-, di- or tristyryl phenol ethoxylate.

In some embodiments, the agrochemical emulsion concentrate composition comprises at least one non-ionic tristyryl phenol ethoxylate and/or at least one anionic tristyryl phenol ethoxylate.

In some embodiments, the amount of the at least one non-ionic mono-, di- or tristyryl phenol ethoxylate is of about 0.5% to about 20% by weight, based on the total weight of the composition.

In some embodiments, the amount of the at least one non-ionic mono-, di- or tristyryl phenol ethoxylate is of about 0.5% to about 10% by weight, based on the total weight of the composition.

In some embodiments, the amount of the at least one anionic mono-, di- or tristyryl phenol ethoxylate is of about 0.5% to about 20% by weight, based on the total weight of the composition.

In some embodiments, the amount of the at least one anionic mono-, di- or tristyryl phenol ethoxylate is of about 0.5% to about 10% by weight, based on the total weight of the composition.

In some embodiments, the amount of the at least one non-ionic tristyryl phenol ethoxylate is of about 0.5% to about 20% by weight, based on the total weight of the composition.

In some embodiments, the amount of the at least one non-ionic tristyryl phenol ethoxylate is of about 0.5% to about 10% by weight, based on the total weight of the composition.

In some embodiments, the amount of the at least one anionic tristyryl phenol ethoxylate is of about 0.5% to about 20% by weight, based on the total weight of the composition.

In some embodiments, the amount of the at least one anionic tristyryl phenol ethoxylate is of about 0.5% to about 10% by weight, based on the total weight of the composition.

In some embodiments, the agrochemical emulsion concentrate composition comprises at least one non-ionic tristyryl phenol ethoxylate and at least one anionic tristyryl phenol ethoxylate.

In some embodiments, the amount of the at least one non-ionictristyryl phenol ethoxylate is of about 0.5% to about 20% and the amount of the at least one anionic tristyryl phenol ethoxylate is of about 0.5% to about 20% by weight, based on the total weight of the composition.

In some embodiments, the amount of the at least one non-ionictristyryl phenol ethoxylate is of about 0.5% to about 10% and the amount of the at least one anionic tristyryl phenol ethoxylate is of about 0.5% to about 10% by weight, based on the total weight of the composition.

In some embodiments, the amount of the at least one non-ionictristyryl phenol ethoxylate is of about 6% and the amount of the at least one anionic tristyryl phenol ethoxylate is of about 6% by weight, based on the total weight of the composition.

In some embodiments, the triazole fungicide is in a concentration ranging from about 30 g/l to about 250 g/l of the composition. In some embodiments, the triazole fungicide is in a concentration ranging from about 50 g/l to about 200 g/l of the composition. In some embodiments, the triazole fungicide is in a concentration of about 150 g/l of the composition.

In some embodiments, prothioconazole is in a concentration ranging from about 30 g/l to about 250 g/l of the composition. In some embodiments, prothioconazole is in a concentration ranging from about 50 g/l to about 200 g/l of the composition. In some embodiments, prothioconazole is in a concentration of about 150 g/l of the composition.

The present invention also provides a method for controlling and/or preventing pests comprising applying an effective amount of the composition disclosed herein to a locus where the pest is to be controlled and/or prevented so as to thereby control and/or prevent the pest.

In some embodiments, the pest is a phytopathogenic harmful fungi.

In some embodiments, the locus where the pest is to be controlled and/or prevented is a crop field.

The present invention also provides a method for controlling and/or preventing phytopathogenic harmful fungi comprising applying an effective amount of the composition disclosed herein to a locus where the phytopathogenic harmful fungi is to be controlled so as to thereby control the phytopathogenic harmful fungi.

In some embodiments, the locus where the pest is to be controlled and/or prevented is a crop field.

The present invention also provides a method of controlling phytopathogenic harmful fungi in a field of crop comprising applying an effective amount of the composition disclosed herein to a field of crop so as to thereby control the phytopathogenic harmful fungi in the field of crop.

In some embodiments, the crop is selected from the group consisting of cotton, flax, grapevines, fruit, vegetables, such as Rosaceae sp. (for example pome fruit such as apples and pears, but also stone fruit such as apricots, cherries, almonds and peaches, and berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, organs and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers), Alliaceae sp. (for example leeks, onions), Papilionaceae sp. (for example peas); main crop plants such as Gramineae sp. (for example maize, turfgrass, cereals such as wheat, rye, rice, barley, oats, sorghum/millet and triticale), Asteraceae sp. (for example sunflowers), Brassicaceae sp. (for example white cabbage, red cabbage, broccoli, cauliflower, Brussels sprouts, Pak Choi, kohlrabi, radishes, and rapeseed, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodder beet, chard, beetroot); sugarcane, poppies, olives, coconuts, cocoa, tobacco and useful plants and ornamental plants in gardens and forests; and genetically modified varieties of each of these plants, and the seeds of these plants. In a preferred embodiment, the crop is selected from the group consisting of wheat, rye, rice, barley, oats, sorghum/millet, triticale, maize, rapeseed, beans, peanuts and sunflowers. In a more preferred embodiment, the crop is selected from the group consisting of wheat, rye, rice, barley, oats, sorghum/millet and triticale.

Non-limiting examples of pathogens of fungal diseases which may be treated in accordance with the invention include: diseases caused by powdery mildew pathogens, for example Blumeria species, for example Blumeria graminis, Podosphaera species, for example Podosphaera leucotricha, Sphaerotheca species, for example Sphaerotheca fuliginea, Uncinula species, for example Uncinula necator, for example Erysiphe species; diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae Puccinia species, for example Puccinia recondita, Puccinia graminis oder Puccinia striiformis, Uromyces species, for example Uromyces appendiculatus, diseases caused by pathogens from the group of the Oomycetes, for example Albugo species, for example Albugo candida, Bremia species, for example Bremia laciucaer, Peronospora species, for example Peronospora pisi or P. brassicaer, Phytophthora species, for example Phytophthora infestans, Plasmopara species, for example Plasmopara viticola, Pseudoperonospora species, for example Pseudoperonospora humuli or Pseudoperonospora cubensis, Pythium species, for example Pythium ultimunv, leaf blotch diseases and leaf wilt diseases caused, for example, by Alternaria species, lor example Alternaria solanv, Cercospora species, for example Cercospora beticola, Cladiosporium species, for example Cladiosporium cucumerinunr, Cochliobolus species, for example Cochliobolus sativus (conidial form: Drechslera, syn: Helminthosporium) or Cochliobolus miyabeanus, Colletotrichum species, for example Colletotrichum lindemuthaniunv, Corynespora species, for example Corynespora cassiicola, Cycloconium species, for example Cycloconium oleaginunv, Diaporthe species, for example Diaporthe citrv, Elsinoe species, for example Elsinoe fawcettii, Gloeosporium species, for example Gloeosporium laeticolor, Glomerella species, for example Glomerella cingulata, Guignardia species, for example Guignardia bidwellv, Leptosphaeria species, for example Leptosphaeria maculans, Magnaporthe species, for example Magnaporthe grisea, Microdochium species, for example Microdochium nivaler, Mycosphaerella species, for example Mycosphaerella graminicola (also known as Septoria tritici), Mycosphaerella arachidicola or Mycosphaerella fijiens, Phaeosphaeria species, for example Phaeosphaeria nodorunr, Pyrenophora species, for example Pyrenophora teres or Pyrenophora tritici rep enth, Ramularia species, for example Ramularia collo-cygni or Ramularia areola, Rhynchosporium species, for example Rhynchosporium secalis, Septoria species, for example Septoria apii or Septoria lycopersicv, Stagonospora species, for example Stagonospora nodorunr, Typhula species, for example Typhula incarnata, Venturia species, for example Venturia inaequal, root and stem diseases caused, for example, by Corticium species, for example Corticium graminearum, Fusarium species, for example Fusarium oxysporum\Gaeumannomyces species, for example Gaeumannomyces graminis, Plasmodiophora species, for example Plasmodiophora brassica, Rhizoctonia species, for example Rhizoctonia solani, Sarocladium species, for example Sarocladium oryzae; Sclerotium species, for example Sclerotium oryzae, Tapesia species, for example Tapesia acuformis, Thielaviopsis species, for example Thielaviopsis basicola, ear and panicle diseases (including corn cobs) caused, for example, by Alternaria species, for example Alternaria spp.; Aspergillus species, for example Aspergillus flavus, Cladosporium species, for example Cladosporium cladosporioides, Claviceps species, for example Claviceps purpurea, Fusarium species, for example Fusarium culmorunr, Gibberella species, for example Gibberella zeae Monographella species, for example Monographella nivalis, Stagnospora species, for example Stagnospora nodorunr, diseases caused by smut fungi, for example Sphacelotheca species, for example Sphacelotheca reiliana, Tilletia species, for example Tilletia caries or Tilletia controversy, Urocystis species, for example Urocystis occulta, Ustilago species, for example Ustilago nuda, fruit rot caused, for example, by Aspergillus species, for example Aspergillus flavus, Botrytis species, for example Botrytis cinerea, Monilinia species, for example Monilinia lαχα, Penicillium species, for example Penicillium expansum or Penicillium purpurogenum, Rhizopus species, for example Rhizopus stolonifer, Sclerotinia species, for example Sclerotinia sclerotiorum, Verticilium species, for example Verticilium alboatrum, seed- and soil-bome rot and wilt diseases, and also diseases of seedlings, caused, for example, by Alternaria species, for example Alternaria brassideola Aphanomyces species, for example Aphanomyces euteiches, Ascochyta species, for example Ascochyta lends, Aspergillus species, or example Aspergillus flavus, Cladosporium species, for example Cladosporium herbarum, Cochliobolus species, for example Cochliobolus sativus (conidial form: Drechslera, Bipolaris Syn: Helminthosporium), Colletotrichum species, for example Colletotrichum coccodes, Fusarium species, for example Fusarium culmorum, Gibberella species, for example Gibberella zeae Macrophomina species, for example Macrophomina phaseolina, Microdochium species, for example Microdochium nivale, Monographella species, for example Monographella nivalis, Penicillium species, for example Penicillium expansum, Phoma species, for example Phoma lingam, Phomopsis species, for example Phomopsis soae Phytophthora species, for example Phytophthora cactorum, Pyrenophora species, for example Pyrenophora graminea, Pyricularia species, for example Pyricularia oryzac, Pythium species, for example Pythium ultimum, Rhizoctonia species, for example Rhizoctonia solanv, Rhizopus species, for example Rhizopus oryzae; Sclerotium species, for example Sclerotium rolfsii, Septoria species, for example Septoria nodorum, Typhula species, for example Typhula incarnata, Verticillium species, for example Verticillium dahliae, cancers, galls and witches' broom caused, for example, by Nectria species, for example Nectria galligena, wilt diseases caused, for example, by Verticillium species, for example Verticillium longisporunr, Fusarium species, for example Fusarium oxysporurrv, deformations of leaves, flowers and fruits caused, for example, by Exobasidium species, for example Exobasidium vexans, Taphrina species, for example Taphrina deformans, degenerative diseases in woody plants, caused, for example, by Esca species, for example Phaeomoniella chlamydospora, Phaeoacremonium aleophilum or Fomitiporia mediterranean Ganoderma species, for example Ganoderma boninense, diseases of plant tubers caused, for example, by Rhizoctonia species, for example Rhizoctonia solanv, Helminthosporium species, for example Helminthosporium solanv, diseases caused by bacterial pathogens, for example Xanthomonas species, for example Xanthomonas campestris pv. oryzae, Pseudomonas species, for example Pseudomonas syringae pv. lachrymans, Erwinia species, for example Erwinia amylovora, Liberibacter species, for example Liberibacter asiaticus, Xyella species, for example Xylella fastidiosa, Ralstonia species, for example Ralstonia solanacearum, Dickeya species, for example Dickeya solanv, Clavibacter species, for example Clavibacter michiganensis, Streptomyces species, for example Streptomyces scabies. diseases of soya beans: fungal diseases on leaves, stems, pods and seeds caused, for example, by Alternaria leaf spot (Alternaria spec atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.j), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), mst (Phakopsora pachyrhizi, Phakopsora meibomiae), scab (Sphaceloma glycines), stemphylium leaf blight (Stemphylium botryosum), sudden death syndrome (Fusarium virguliforme), target spot (Corynespora cassiicola). Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythiumrot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

The phytopathogenic harmful fungi is selected from Septoria species, Fusarium species, Puccinia species, Erisyphe species, Drechslera species, Ramularia species, Mycosphaerella species and Rhynchosporium species.

In some embodiments, the phytopathogenic harmful fungi is selected from Puccinia recondita, Septoria tritici, Fusarium culmorum, Pyrenophora teres and Rhynchosporium secalis.

In some embodiments, the crop is selected from the group consisting of wheat, rye, rice, barley, oats, sorghum/millet, triticale, maize, rapeseed, beans, peanuts and sunflowers.

In some embodiments, the composition is applied in an amount from about 0.25 L/ha to about 2.0 L/ha.

The present invention also provides a use of the composition disclosed herein for controlling and/or preventing pests.

The present invention also provides a use of the composition disclosed herein for controlling and/or preventing harmful fungi.

By another aspect, the invention provides use of a combination of a carbonyl containing solvent an adjuvant of formula (I)

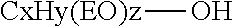

in which X is 6-13, Y is 14-28, and Z is 3-13 for increasing the efficacy of SDHI fungicides.

In some embodiments, the carbonyl containing solvent is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctenone (30), 2,4,6-cycloheptatrien-1-one, acetophenone, propiophenone (19), 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In some embodiments, the ketone is cyclohexanone, acetophenone, heptanone and any mixtures thereof. In one embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In some embodiments the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, the SDHI fungicide is selected from the group consisting of benodanil, flutolanil, mepronil, isofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, pydiflumetofen, pyraziflumid and any combination thereof. In some embodiments, the SDHI fungicide is fluxapyroxad.

In some embodiments, the adjuvant of formula (I) in which X is 13, Y is 27, and Z is between 7 to 15.

In some embodiments, the ratio between the carbonyl containing solvent and the adjuvant of formula (I) is of about 60:1 to about 1:2. In some embodiments, the ratio between the carbonyl containing solvent and the adjuvant of formula (I) is of about 10:3 to about 4:3. In some embodiments, the ratio between the carbonyl containing solvent and the adjuvant of formula (I) is of about 3.5:1.

In some embodiments, the ratio between acetophenone and the adjuvant of formula (I) is of about 60:1 to about 1:2. In some embodiments, the ratio between acetophenone and the adjuvant of formula (I) is of about 10:3 to about 4:3. In some embodiments, the ratio between acetophenone and the adjuvant of formula (I) is of about 3.5:1.

In some embodiments, the ratio between acetophenone and the adjuvant of formula (I) in which X is 13, Y is 27, and Z is between 7-15 is of about 60:1 to about 1:2. In some embodiments, the ratio between acetophenone and the adjuvant of formula (I) in which X is 13, Y is 27, and Z is between 7-15 is of about 10:3 to about 4:3. In some embodiments, the ratio between acetophenone and the adjuvant of formula (I) in which X is 13, Y is 27, and Z is between 7-15 is of about 3.5:1.

In some embodiments, the invention provides the use of a combination of acetophenone an adjuvant of formula (I)

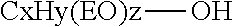

in which X is 6-13, Y is 14-28, and Z is 3-13 for increasing the efficacy of SDHI fungicides.

In some embodiments, the invention provides the use of a combination of acetophenone and adjuvant of formula (I)

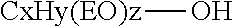

in which X is 6-13, Y is 14-28, and Z is 3-13 wherein, the ratio between acetophenone and the adjuvant of formula (I) is of about 60:1 to about 1:2 for increasing the efficacy of SDHI fungicides.

In some embodiments, the invention provides the use of a combination of acetophenone an adjuvant of formula (I)

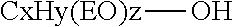

in which X is 6-13, Y is 14-28, and Z is 3-13 wherein, the ratio between acetophenone and the adjuvant of formula (I) is of about 10:3 to about 4:3 for increasing the efficacy of SDHI fungicides.

In some embodiments, the invention provides the use of a combination of acetophenone an adjuvant of formula (I)

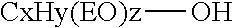

in which X is 6-13, Y is 14-28, and Z is 3-13 wherein, the ratio between acetophenone and the adjuvant of formula (I) is of about 3.5:1 for increasing the efficacy of SDHI fungicides.

In some embodiments, the invention provides the use of a combination of acetophenone and adjuvant of formula (I)

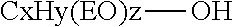

in which X is 6-13, Y is 14-28, and Z is 3-13 wherein, the ratio between acetophenone and the adjuvant of formula (I) is of about 60:1 to about 1:2 for increasing the efficacy of fluxapyroxad.

In some embodiments, the invention provides the use of a combination of acetophenone an adjuvant of formula (I)

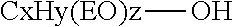

in which X is 6-13, Y is 14-28, and Z is 3-13 wherein, the ratio between acetophenone and the adjuvant of formula (I) is of about 10:3 to about 4:3 for increasing the efficacy of fluxapyroxad.

In some embodiments, the invention provides the use of a combination of acetophenone an adjuvant of formula (I)

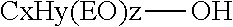

in which X is 6-13, Y is 14-28, and Z is 3-13 wherein, the ratio between acetophenone and the adjuvant of formula (I) is of about 3.5:1 for increasing the efficacy of fluxapyroxad.

In some embodiments, the invention provides the use of a combination of acetophenone an adjuvant of formula (I)

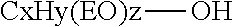

in which X is 13, Y is 27, and Z is between 7 to 15 for increasing the efficacy of SDHI fungicides.

In some embodiments, the invention provides the use of a combination of acetophenone an adjuvant of formula (I)

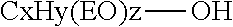

in which X is 13, Y is 27, and Z is between 7 to 15 wherein, the ratio between acetophenone and the adjuvant of formula (I) is of about 60:1 to about 1:2 for increasing the efficacy of SDHI fungicides.

In some embodiments, the invention provides the use of a combination of acetophenone an adjuvant of formula (I)

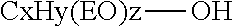

in which X is 13, Y is 27, and Z is between 7 to 15 wherein, the ratio between acetophenone and the adjuvant of formula (I) is of about 10:3 to about 4:3 for increasing the efficacy of SDHI fungicides.

In some embodiments, the invention provides the use of a combination of acetophenone an adjuvant of formula (I)

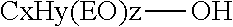

in which X is 13, Y is 27, and Z is between 7 to 15 wherein, the ratio between acetophenone and the adjuvant of formula (I) is of about 3.5:1 for increasing the efficacy of SDHI fungicides.

In some embodiments, the invention provides the use of a combination of acetophenone an adjuvant of formula (I)

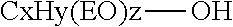

in which X is 13, Y is 27, and Z is between 7 to 15 wherein, the ratio between acetophenone and the adjuvant of formula (I) is of about 60:1 to about 1:2 for increasing the efficacy of fluxapyroxad.

In some embodiments, the invention provides the use of a combination of acetophenone an adjuvant of formula (I)

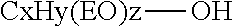

in which X is 13, Y is 27, and Z is between 7 to 15 wherein, the ratio between acetophenone and the adjuvant of formula (I) is of about 10:3 to about 4:3 for increasing the efficacy of fluxapyroxad.

In some embodiments, the invention provides the use of a combination of acetophenone an adjuvant of formula (I)

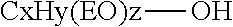

in which X is 13, Y is 27, and Z is between 7 to 15 wherein, the ratio between acetophenone and the adjuvant of formula (I) is of about 3.5:1 for increasing the efficacy of fluxapyroxad.

In some embodiments, the invention provides the use of a combination of acetophenone an adjuvant of formula (I)

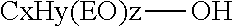

in which X is 6-13, Y is 14-28, Z is 3-13 for increasing the efficacy of fluxapyroxad.

In some embodiments, the invention provides the use of a combination of acetophenone an adjuvant of formula (I)

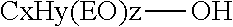

in which X is 13, Y is 27, and Z is between 7 to 15 for increasing the efficacy of fluxapyroxad.

By another aspect, the invention provides a combination of a carbonyl containing solvent and adjuvant of formula (I)

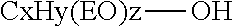

in which X is 6-13, Y is 14-28, and Z is 3-13 for increasing the efficacy of SDHI fungicides.

In some embodiments, the carbonyl containing solvent is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctenone (30), 2,4,6-cycloheptatrien-1-one, acetophenone, propiophenone (19), 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In some embodiments, the ketone is cyclohexanone, acetophenone, heptanone and any mixtures thereof. In one embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In some embodiments the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, the SDHI fungicide is selected from the group consisting of benodanil, flutolanil, mepronil, isofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, pydiflumetofen, pyraziflumid and any combination thereof. In some embodiments, the SDHI fungicide is fluxapyroxad.

In some embodiments, the adjuvant of formula (I) in which X is 13, Y is 27, and Z is between 7 to 15.

In some embodiments, the ratio between the carbonyl containing solvent and the adjuvant of formula (I) is of about 60:1 to about 1:2. In some embodiments, the ratio between the carbonyl containing solvent and the adjuvant of formula (I) is of about 10:3 to about 4:3. In some embodiments, the ratio between the carbonyl containing solvent and the adjuvant of formula (I) is of about 3.5:1.

In some embodiments, the ratio between acetophenone and the adjuvant of formula (I) is of about 60:1 to about 1:2. In some embodiments, the ratio between acetophenone and the adjuvant of formula (I) is of about 10:3 to about 4:3. In some embodiments, the ratio between acetophenone and the adjuvant of formula (I) is of about 3.5:1.

In some embodiments, the ratio between acetophenone and the adjuvant of formula (I) in which X is 13, Y is 27, and Z is between 7-15 is of about 60:1 to about 1:2. In some embodiments, the ratio between acetophenone and the adjuvant of formula (I) in which X is 13, Y is 27, and Z is between 7-15 is of about 10:3 to about 4:3. In some embodiments, the ratio between acetophenone and the adjuvant of formula (I) in which X is 13, Y is 27, and Z is between 7-15 is of about 3.5:1.

In some embodiments, the invention provides the combination of acetophenone an adjuvant of formula (I)

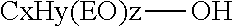

in which X is 6-13, Y is 14-28, and Z is 3-13 for increasing the efficacy of SDHI fungicides.

In some embodiments, the invention provides the combination of acetophenone and adjuvant of formula (I)

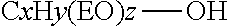

in which X is 6-13, Y is 14-28, and Z is 3-13 wherein, the ratio between acetophenone and the adjuvant of formula (I) is of about 60:1 to about 1:2 for increasing the efficacy of SDHI fungicides.

In some embodiments, the invention provides the combination of acetophenone an adjuvant of formula (I)

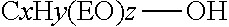

in which X is 6-13, Y is 14-28, and Z is 3-13 wherein, the ratio between acetophenone and the adjuvant of formula (I) is of about 10:3 to about 4:3 for increasing the efficacy of SDHI fungicides.

In some embodiments, the invention provides the combination of acetophenone an adjuvant of formula (I)

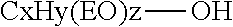

in which X is 6-13, Y is 14-28, and Z is 3-13 wherein, the ratio between acetophenone and the adjuvant of formula (I) is of about 3.5:1 for increasing the efficacy of SDHI fungicides.

In some embodiments, the invention provides the combination of acetophenone and adjuvant of formula (I)

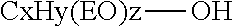

in which X is 6-13, Y is 14-28, and Z is 3-13 wherein, the ratio between acetophenone and the adjuvant of formula (I) is of about 60:1 to about 1:2 for increasing the efficacy of fluxapyroxad.

In some embodiments, the invention provides the combination of acetophenone an adjuvant of formula (I)

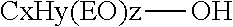

in which X is 6-13, Y is 14-28, and Z is 3-13 wherein, the ratio between acetophenone and the adjuvant of formula (I) is of about 10:3 to about 4:3 for increasing the efficacy of fluxapyroxad.

In some embodiments, the invention provides the combination of acetophenone an adjuvant of formula (I)

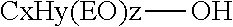

in which X is 6-13, Y is 14-28, and Z is 3-13 wherein, the ratio between acetophenone and the adjuvant of formula (I) is of about 3.5:1 for increasing the efficacy of fluxapyroxad.

In some embodiments, the invention provides the combination of acetophenone an adjuvant of formula (I)

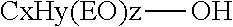

in which X is 13, Y is 27, and Z is between 7 to 15 for increasing the efficacy of SDHI fungicides.

In some embodiments, the invention provides the combination of acetophenone an adjuvant of formula (I)

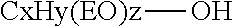

in which X is 13, Y is 27, and Z is between 7 to 15 wherein, the ratio between acetophenone and the adjuvant of formula (I) is of about 60:1 to about 1:2 for increasing the efficacy of SDHI fungicides.

In some embodiments, the invention provides the combination of acetophenone an adjuvant of formula (I)

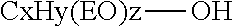

in which X is 13, Y is 27, and Z is between 7 to 15 wherein, the ratio between acetophenone and the adjuvant of formula (I) is of about 10:3 to about 4:3 for increasing the efficacy of SDHI fungicides.

In some embodiments, the invention provides the combination of acetophenone an adjuvant of formula (I)

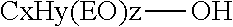

in which X is 13, Y is 27, and Z is between 7 to 15 wherein, the ratio between acetophenone and the adjuvant of formula (I) is of about 3.5:1 for increasing the efficacy of SDHI fungicides.

In some embodiments, the invention provides the combination of acetophenone an adjuvant of formula (I)

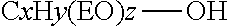

in which X is 13, Y is 27, and Z is between 7 to 15 wherein, the ratio between acetophenone and the adjuvant of formula (I) is of about 60:1 to about 1:2 for increasing the efficacy of fluxapyroxad.

In some embodiments, the invention provides the combination of acetophenone an adjuvant of formula (I)

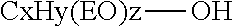

in which X is 13, Y is 27, and Z is between 7 to 15 wherein, the ratio between acetophenone and the adjuvant of formula (I) is of about 10:3 to about 4:3 for increasing the efficacy of fluxapyroxad.

In some embodiments, the invention provides the combination of acetophenone an adjuvant of formula (I)

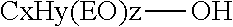

in which X is 13, Y is 27, and Z is between 7 to 15 wherein, the ratio between acetophenone and the adjuvant of formula (I) is of about 3.5:1 for increasing the efficacy of fluxapyroxad.

In some embodiments, the invention provides the combination of acetophenone an adjuvant of formula (I)

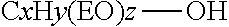

in which X is 6-13, Y is 14-28, and Z is 3-13 for increasing the efficacy of fluxapyroxad.

In some embodiments, the invention provides the combination of acetophenone an adjuvant of formula (I)

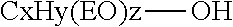

wherein X is 13, Y is 27, and Z is between 7 to 15 for increasing the efficacy of fluxapyroxad.

The present invention also provides a method of control of crystal growth of SDHI fungicide in agrochemical emulsion by addition of a) carbonyl containing solvent, b) N-alkyl pyrrolidone of formula (II):

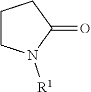

wherein R1 is a straight or branched, saturated or unsaturated, substituted or unsubstituted hydrocarbon group having from 4 to 10 carbon atoms and c) adjuvant of formula (I)

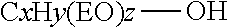

in which X is 6-13, Y is 14-28 and Z is 3-13.

In some embodiments, the SDHI fungicide is selected from the group consisting of benodanil, flutolanil, mepronil, isofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, pydiflumetofen, pyraziflumid and any combination thereof. In some embodiments, the at least one SDHI fungicide is fluxapyroxad.

In some embodiments, the carbonyl containing solvent is selected from the groups of ketones, amides, ureas, esters, lactones, carbonates and any mixtures thereof.

In some embodiments, the ketone solvent is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctenone (30), 2,4,6-cycloheptatrien-1-one, acetophenone, propiophenone (19), 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof. In some embodiments, the ketone is cyclohexanone, acetophenone, heptanone and any mixtures thereof. In one embodiment, the ketone is acetophenone.

In some embodiments, the amide solvent is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof. In some embodiments the amide is N,N-dimethyldecanamide, N,N-dimethyldecenamide, N,N-dimethyl-octanamide and any mixtures thereof.

In some embodiments, the urea solvent is selected from tetramethylurea, tetraethylurea and any mixture thereof.

In some embodiments, the lactone solvent is selected from butyrolactone, alpha-methyl-gamma-butyrolactone, gamma-valerolactone, delta-valerolactone and any mixture thereof.

In some embodiments, the carbonate solvent is selected from dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one, dibenzyl carbonate and any mixture thereof.

In some embodiments, in formula (II) R1 is a hydrocarbon group having from 7 to 9 carbon atoms. In some embodiments, in formula (II) R1 is a hydrocarbon group having 8 carbon atoms.

In some embodiments, the N-alkyl pyrrolidone of formula (II) is 1-octyl-2-pyrrolidone.

In some embodiments, the adjuvant of formula (I) in which X is 13, Y is 27, and Z is between 7 to 15.

The present invention also provides a method of control of crystal growth of SDHI fungicide in agrochemical emulsion by addition of a) carbonyl containing solvent, b) N-alkyl pyrrolidone of formula (II):

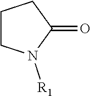

wherein R1 is a straight or branched, saturated or unsaturated, substituted or unsubstituted hydrocarbon group having from 4 to 10 carbon atoms and c) adjuvant of formula (I)

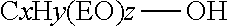

in which X is 6-13, Y is 14-28 and Z is 3-13; wherein the ratio between a and b is of about 30:1 to about 1:5.

The present invention also provides a method of control of crystal growth of SDHI fungicide in agrochemical emulsion by addition of a) carbonyl containing solvent, b) N-alkyl pyrrolidone of formula (II):

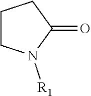

wherein R1 is a straight or branched, saturated or unsaturated, substituted or unsubstituted hydrocarbon group having from 4 to 10 carbon atoms and c) adjuvant of formula (I)

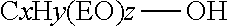

in which X is 6-13, Y is 14-28 and Z is 3-13; wherein the ratio between a and b is of about 25:1 to about 2:3.

The present invention also provides a method of control of crystal growth of SDHI fungicide in agrochemical emulsion by addition of a) carbonyl containing solvent, b) N-alkyl pyrrolidone of formula (III):

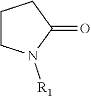

wherein R1 is a straight or branched, saturated or unsaturated, substituted or unsubstituted hydrocarbon group having from 4 to 10 carbon atoms and c) adjuvant of formula (I)

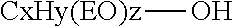

in which X is 6-13, Y is 14-28 and Z is 3-13; wherein the ratio between a and b is of about 3:1.

The present invention also provides a method of control of crystal growth of SDHI fungicide in agrochemical emulsion by addition of a) carbonyl containing solvent, b) N-alkyl pyrrolidone of formula (II):

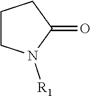

wherein R1 is a straight or branched, saturated or unsaturated, substituted or unsubstituted hydrocarbon group having from 4 to 10 carbon atoms and c) adjuvant of formula (I)

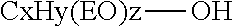

in which X is 6-13, Y is 14-28 and Z is 3-13; wherein the ratio between a and b is of about 2.5:1.

The present invention also provides a method of control of crystal growth of SDHI fungicide in agrochemical emulsion by addition of a) acetophenone, b) N-alkyl pyrrolidone of formula (II):

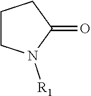

wherein R1 is a straight or branched, saturated or unsaturated, substituted or unsubstituted hydrocarbon group having from 4 to 10 carbon atoms and c) adjuvant of formula (I)

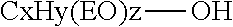

in which X is 6-13, Y is 14-28 and Z is 3-13; wherein the ratio between a and b is of about 30:1 to about 1:5.

The present invention also provides a method of control of crystal growth of SDHI fungicide in agrochemical emulsion by addition of acetophenone, b) N-alkyl pyrrolidone of formula (II):

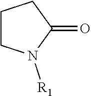

wherein R1 is a straight or branched, saturated or unsaturated, substituted or unsubstituted hydrocarbon group having from 4 to 10 carbon atoms and c) adjuvant of formula (I)

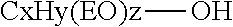

in which X is 6-13, Y is 14-28 and Z is 3-13; wherein the ratio between a and b is of about 25:1 to about 2:3.

The present invention also provides a method of control of crystal growth of SDHI fungicide in agrochemical emulsion by addition of a) acetophenone, b) N-alkyl pyrrolidone of formula (II):

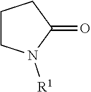

wherein R1 is a straight or branched, saturated or unsaturated, substituted or unsubstituted hydrocarbon group having from 4 to 10 carbon atoms and c) adjuvant of formula (I)

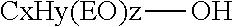

in which X is 6-13, Y is 14-28 and Z is 3-13; wherein the ratio between a and b is of about 3:1.

The present invention also provides a method of control of crystal growth of SDHI fungicide in agrochemical emulsion by addition of a) acetophenone, b) N-alkyl pyrrolidone of formula (II):

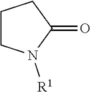

wherein R1 is a straight or branched, saturated or unsaturated, substituted or unsubstituted hydrocarbon group having from 4 to 10 carbon atoms and c) adjuvant of formula (I)

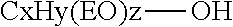

in which X is 6-13, Y is 14-28 and Z is 3-13; wherein the ratio between a and b is of about 2.5:1.

The present invention also provides a method of control of crystal growth of fluxapyroxad in agrochemical emulsion by addition of a) acetophenone, b) N-alkyl pyrrolidone of formula (II):

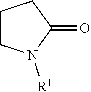

wherein R1 is a straight or branched, saturated or unsaturated, substituted or unsubstituted hydrocarbon group having from 4 to 10 carbon atoms and c) adjuvant of formula (I)

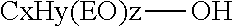

in which X is 6-13, Y is 14-28 and Z is 3-13; wherein the ratio between a and b is of about 3:1.

The present invention also provides a method of control of crystal growth of fluxapyroxad in agrochemical emulsion by addition of a) acetophenone, b) N-alkyl pyrrolidone of formula (II):

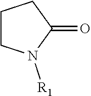

wherein R1 is a straight or branched, saturated or unsaturated, substituted or unsubstituted hydrocarbon group having from 4 to 10 carbon atoms and c) adjuvant of formula (I)

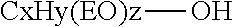

in which X is 6-13, Y is 14-28 and Z is 3-13; wherein the ratio between a and b is of about 2.5:1.

The present invention also provides a method of control of crystal growth of SDHI fungicide in agrochemical emulsion by addition of a) acetophenone, b) 1-octyl-2-pyrrolidone and c) adjuvant of formula (I)

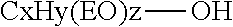

in which X is 6-13, Y is 14-28 and Z is 3-13; wherein the ratio between a and b is of about 30:1 to about 1:5.

The present invention also provides a method of control of crystal growth of SDHI fungicide in agrochemical emulsion by addition of acetophenone, b) N1-octyl-2-pyrrolidone and c) adjuvant of formula (I)

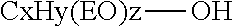

in which X is 6-13, Y is 14-28 and Z is 3-13; wherein the ratio between a and b is of about 25:1 to about 2:3.

The present invention also provides a method of control of crystal growth of SDHI fungicide in agrochemical emulsion by addition of a) acetophenone, b) 1-octyl-2-pyrrolidone and c) adjuvant of formula (I)

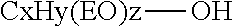

in which X is 6-13, Y is 14-28 and Z is 3-13; wherein the ratio between a and b is of about 3:1.

The present invention also provides a method of control of crystal growth of SDHI fungicide in agrochemical emulsion by addition of a) acetophenone, b) 1-octyl-2-pyrrolidone and c) adjuvant of formula (I)

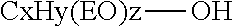

in which X is 13, Y is 27 and Z is 7-15; wherein the ratio between a and b is of about 30:1 to about 1:5.

The present invention also provides a method of control of crystal growth of SDHI fungicide in agrochemical emulsion by addition of acetophenone, b) N1-octyl-2-pyrrolidone and c) adjuvant of formula (I)

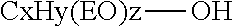

in which X is 13, Y is 27 and Z is 7-15; wherein the ratio between a and b is of about 25:1 to about 2:3.

The present invention also provides a method of control of crystal growth of SDHI fungicide in agrochemical emulsion by addition of a) acetophenone, b) 1-octyl-2-pyrrolidone and c) adjuvant of formula (I)

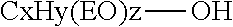

in which X is 13, Y is 27 and Z is 7-15; wherein the ratio between a and b is of about 3:1.

The present invention also provides a method of control of crystal growth of fluxapyroxad in agrochemical emulsion by addition of a) acetophenone, b) 1-octyl-2-pyrrolidone and c) adjuvant of formula (I)

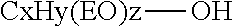

in which X is 6-13, Y is 14-28 and Z is 3-13; wherein the ratio between a and b is of about 30:1 to about 1:5.

The present invention also provides a method of control of crystal growth of fluxapyroxad in agrochemical emulsion by addition of acetophenone, b) N1-octyl-2-pyrrolidone and c) adjuvant of formula (I)

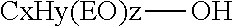

in which X is 6-13, Y is 14-28 and Z is 3-13; wherein the ratio between a and b is of about 25:1 to about 2:3.

The present invention also provides a method of control of crystal growth of fluxapyroxad in agrochemical emulsion by addition of a) acetophenone, b) 1-octyl-2-pyrrolidone and c) adjuvant of formula (I)

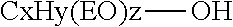

in which X is 6-13, Y is 14-28 and Z is 3-13; wherein the ratio between a and b is of about 3:1.

The present invention also provides a method of control of crystal growth of fluxapyroxad in agrochemical emulsion by addition of a) acetophenone, b) 1-octyl-2-pyrrolidone and c) adjuvant of formula (I)

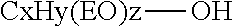

in which X is 13, Y is 27 and Z is 7-15; wherein the ratio between a and b is of about 30:1 to about 1:5.

The present invention also provides a method of control of crystal growth of fluxapyroxad in agrochemical emulsion by addition of acetophenone, b) N1-octyl-2-pyrrolidone and c) adjuvant of formula (I)

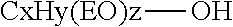

in which X is 13, Y is 27 and Z is 7-15; wherein the ratio between a and b is of about 25:1 to about 2:3.

The present invention also provides a method of control of crystal growth of fluxapyroxad in agrochemical emulsion by addition of a) acetophenone, b) 1-octyl-2-pyrrolidone and c) adjuvant of formula (I)

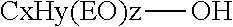

in which X is 13, Y is 27 and Z is 7-15; wherein the ratio between a and b is of about 3:1.

The present invention also provides a method of control of crystal growth of SDHI fungicide in agrochemical emulsion by addition of a) acetophenone, b) 1-octyl-2-pyrrolidone and c) adjuvant of formula (I)

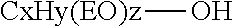

in which X is 13, Y is 27 and Z is 7-15; wherein the ratio between a and b is of about 30:1 to about 1:5 and the amount of c is of about 1% to about 20% by weight, based on the total weight of the composition.

The present invention also provides a method of control of crystal growth of SDHI fungicide in agrochemical emulsion by addition of acetophenone, b) N1-octyl-2-pyrrolidone and c) adjuvant of formula (I)

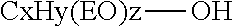

in which X is 13, Y is 27 and Z is 7-15; wherein the ratio between a and b is of about 25:1 to about 2:3 and the amount of c is of about 1% to about 20% by weight, based on the total weight of the composition.

The present invention also provides a method of control of crystal growth of SDHI fungicide in agrochemical emulsion by addition of a) acetophenone, b) 1-octyl-2-pyrrolidone and c) adjuvant of formula (I)

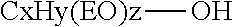

in which X is 13, Y is 27 and Z is 7-15; wherein the ratio between a and b is of about 3:1 and the amount of c is of about 1% to about 20% by weight, based on the total weight of the composition.

The present invention also provides a method of control of crystal growth of SDHI fungicide in agrochemical emulsion by addition of a) acetophenone, b) 1-octyl-2-pyrrolidone and c) adjuvant of formula (I)

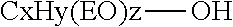

in which X is 13, Y is 27 and Z is 7-15; wherein the ratio between a and b is of about 30:1 to about 1:5 and the amount of c is of about 3% to about 15% by weight, based on the total weight of the composition.

The present invention also provides a method of control of crystal growth of SDHI fungicide in agrochemical emulsion by addition of a acetophenone, b) N1-octyl-2-pyrrolidone and c) adjuvant of formula (I)

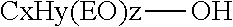

in which X is 13, Y is 27 and Z is 7-15; wherein the ratio between a and b is of about 25:1 to about 2:3 and the amount of c is of about 3% to about 15% by weight, based on the total weight of the composition.

The present invention also provides a method of control of crystal growth of SDHI fungicide in agrochemical emulsion by addition of a) acetophenone, b) 1-octyl-2-pyrrolidone and c) adjuvant of formula (I)

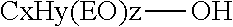

in which X is 13, Y is 27 and Z is 7-15; wherein the ratio between a and b is of about 3:1 and the amount of c is of about 3% to about 15% by weight, based on the total weight of the composition.

The present invention also provides a method of control of crystal growth of fluxapyroxad in agrochemical emulsion by addition of a) acetophenone, b) 1-octyl-2-pyrrolidone and c) adjuvant of formula (I)

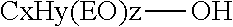

in which X is 13, Y is 27 and Z is 7-15; wherein the ratio between a and b is of about 30:1 to about 1:5 and the amount of c is of about 1% to about 20% by weight, based on the total weight of the composition.

The present invention also provides a method of control of crystal growth of fluxapyroxad in agrochemical emulsion by addition of acetophenone, b) N1-octyl-2-pyrrolidone and c) adjuvant of formula (I)

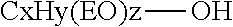

in which X is 13, Y is 27 and Z is 7-15; wherein the ratio between a and b is of about 25:1 to about 2:3 and the amount of c is of about 1% to about 20% by weight, based on the total weight of the composition.

The present invention also provides a method of control of crystal growth of fluxapyroxad in agrochemical emulsion by addition of a) acetophenone, b) 1-octyl-2-pyrrolidone and c) adjuvant of formula (I)

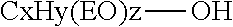

in which X is 13, Y is 27 and Z is 7-15; wherein the ratio between a and b is of about 3:1 and the amount of c is of about 1% to about 20% by weight, based on the total weight of the composition.

The present invention also provides a method of control of crystal growth of fluxapyroxad in agrochemical emulsion by addition of a) acetophenone, b) 1-octyl-2-pyrrolidone and c) adjuvant of formula (I)

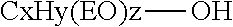

in which X is 13, Y is 27 and Z is 7-15; wherein the ratio between a and b is of about 30:1 to about 1:5 and the amount of c is of about 3% to about 15% by weight, based on the total weight of the composition.

The present invention also provides a method of control of crystal growth of fluxapyroxad in agrochemical emulsion by addition of a acetophenone, b) N1-octyl-2-pyrrolidone and c) adjuvant of formula (I)

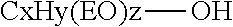

in which X is 13, Y is 27 and Z is 7-15; wherein the ratio between a and b is of about 25:1 to about 2:3 and the amount of c is of about 3% to about 15% by weight, based on the total weight of the composition.

The present invention also provides a method of control of crystal growth of fluxapyroxad in agrochemical emulsion by addition of a) acetophenone, b) 1-octyl-2-pyrrolidone and c) adjuvant of formula (I)

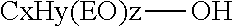

in which X is 13, Y is 27 and Z is 7-15; wherein the ratio between a and b is of about 3:1 and the amount of c is of about 3% to about 15% by weight, based on the total weight of the composition.

In addition, all the compositions and/or combinations of the invention may optionally comprise liquid fillers, for example vegetable or mineral oils or esters of vegetable or mineral oils. Suitable vegetable oils are all oils which can typically be used in agrochemicals and can be obtained from plants. Examples include sunflower oil, rapeseed oil, olive oil, castor oil, colza oil, corn oil, cottonseed oil, walnut oil, coconut oil and soya oil. Possible esters are, for example, ethylhexyl palmitate, ethylhexyl oleate, ethylhexyl myristate, ethylhexyl caprylate, isopropyl myristate, isopropyl palmitate, methyl oleate, methyl palmitate, ethyl oleate. Possible mineral oils are Exxsol D100 and white oils.

All the compositions and/or combinations of the invention may comprise further additives such as emulsifiers, penetrants, wetting agents, spreading agents and/or retention agents. Suitable substances are all of those which can typically be used for this purpose in agrochemicals. Suitable additives are, for example, organomodified polysiloxanes, e.g. BreakThru® OE444, BreakThru® S240, Silwett® L77, Silwett® 408; ethoxy (5) tridecyl mono/di phosphate, e.g. Crodafos™ T5A; Sorbitan monolaurate ethoxylated (20EO), e.g. Tween® 20.

Additional suitable additives which may be present in all the compositions of the invention are defoamers, preservatives, antioxidants, dyes and inert fillers.

Suitable defoamers are all substances which can typically be used for this purpose in agrochemicals. Preference is given to silicone oils, silicone oil formulations, magnesium stearate, phosphinic acids and phosphonic acids. Examples are Silcolapse® 482 from Bluestar Silicones, Silfoam® SCI 132 from Wacker [dimethylsiloxanes and -silicones, CAS No. 63148-62-9], SAG 1538 or SAG 1572 from Momentive [dimethylsiloxanes and -silicones, CAS-Nr. 63148-62-9] or Fluowet® PL 80.

Possible preservatives are all substances which can typically be used for this purpose in agrochemicals. Suitable preservatives are, for example, formulations comprising 5-chloro-2-methyl-4-isothiazolin-3-one [CIT; CAS No. 26172-55-4], 2-methyl-4-isothiazolin-3-one [MIT, CAS No. 2682-204] or 1,2-benzisothiazol-3(2H)-one [BIT, CAS No. 2634-33-5]. Examples include Preventol® D7 (Lanxess), Kathon® CG/ICP (Rohm & Haas), Acticide® SPX (Thor GmbH) and Proxel® GXL (ArchChemicals).

Suitable antioxidants are all substances which can typically be used for this purpose in agrochemicals. Preference is given to butylhydroxytoluene [3,5-di-tert-butyl-4-hydroxytoluene, CAS No. 128-37-0] and citric acid.

Possible dyes are all substances which can typically be used for this purpose in agrochemicals. Examples include titanium dioxide, carbon black, zinc oxide, blue pigments, red pigments and Permanent Red FGR.

Suitable inert fillers are all substances which can typically be used for this purpose in agrochemicals, and which do not function as thickeners. Preference is given to inorganic particles such as carbonates, silicates and oxides, and also organic substances such as urea-formaldehyde condensates. Examples include kaolin, rutile, silicon dioxide (“finely divided silica”), silica gel and natural and synthetic silicates, and additionally talc.

All the compositions and/or combinations of the invention can be applied in undiluted form or diluted with water. In general, they are diluted with at least one part water, preferably with 10 parts water and more preferably with at least 100 parts water, for example with 1 to 10000, preferably 10 to 5000 and more preferably with 50 to 24,000 parts water, based on one part of the formulation.

The present invention likewise provides an emulsion obtainable by mixing water with the liquid compositions of the invention. The mixing ratio of water to emulsion concentrate may be in the range from 1500:1 to 1:1, preferably 500:1 to 10:1.

The dilution is achieved by pouring the emulsion concentrates of the invention into the water. For rapid mixing of the concentrate with water, it is customary to use agitation, for example stirring. However, agitation is generally unnecessary. Even though the temperature for the dilution operation is an uncritical factor, dilutions are typically conducted at temperatures in the range from 00° C. to 50° C., especially at 10° C. to 30° C. or at ambient temperature.

The water used for dilution is generally tap water. The water may, however, already contain water soluble or finely dispersed compounds which are used in crop protection, for instance nutrients, fertilizers or pesticides. It is possible to add various kinds of oils, wetting agents, adjuvants, fertilizers or micronutrients and further pesticides (e.g., herbicides, insecticides, fungicides, growth regulators, safeners) to the emulsion of the invention in the form of a premix or, if appropriate, not until shortly before use (tank-mix). These may be added to the compositions of the invention in a weight ratio of 1:100 to 100:1, preferably 1:10 to 10:1.

The user will apply the compositions of the invention typically from a pre-dosing system, a backpack sprayer, a spraying tank, a spraying aircraft or an irrigation system; the composition of the invention is typically diluted to the desired deployment concentration with water, buffer and/or further auxiliaries, which affords the ready-to-use spray liquid or agrochemical composition of the invention. Typically, 20 to 2000 liters, preferably 50 to 400 liters, of the ready-to-use spray liquid are deployed per hectare of useful agricultural area.

The generally diluted compositions of the invention are applied mainly by spraying, especially spraying of the leaves. Application can be conducted by spraying techniques known to those skilled in the art, for example using water as carrier and amounts of spray liquid of about 50 to 1000 liters per hectare, for example from 100 to 200 liters per hectare.

The novel SDHI containing compositions have advantageous properties in respect of the treatment of plants; more particularly, they feature good use properties, high stability and high fungicidal activity.

The invention is illustrated by the following examples without limiting it thereby.

### EXAMPLES

### Example 1

TABLE 1
Formulation A

| Ingredient | Chemical Name | w/w |
|---|---|---|
| Fluxapyroxad tech | 3-(difluoromethyl)-1-methyl-N- | 6.94 |
| | (3′,4′,5′-trifluorobiphenyl-2- | |
| | yl)pyrazole-4-carboxamide | |
| Prothioconazole | 2-[(2RS)-2-(1-chlorocyclopropyl)-3- | 13.88 |
| tech | (2-chlorophenyl)-2-hydroxypropyl]- | |
| | 2H-1,2,4-triazole-3(4H)-thione | |
| Agsolex 8 | (A) 1-octylpyrrolidine-2-one, (B) | 16.11 |
| | Octylamine, (C) Dioctylamine, (D) | |
| | gama-Butyrolactone | |
| Genapol x 080 | Alcohols, C11-14-iso-, C13-rich, | 11.11 |
| | ethoxylated | |
| Soprophor 3 D 33 | (A) 2,4,6-Tris(1- | 6.02 |
| | phenylethyl)polyoxyethylenated | |
| | phosphates, (B)Poly(oxy-1,2- | |
| | ethanediyl), .alpha.-[tris(1- | |
| | phenylethyl)phenyl]-.omega.- | |
| | hydroxy-, (C)orthophosphoric acid | |
| | (POLYARYLPHENYL ETHER | |
| | PHOSPHATE) | |
| Soprophor BSU | Poly(oxy-1,2-ethanediyl), .alpha.- | 6.02 |
| | [tris(1-phenylethyl)phenyl]-.omega.-hydroxy | |
| Acetophenone | Acetophenone | Up to |
| | | 100% |

### Preparation Procedure:

Acetophenone and Agsolex 8 were charged into the reaction vessel and were heated to 35° C.

Fluxapyroxad and Prothioconazole were added and mixed until homogeneous solution was obtained.

Genapol X80, Soprophor 3D33 and Soprophor BSU were added and mixed until homogeneous solution was obtained which than cooled to room temperature (25° C.±5° C.).

The solution was filtered through 8 μm filter paper (Grade 40).

TABLE 2
Cold stability tests of formulation A

| Sample | Cold conditions with | Cold conditions |
|---|---|---|
| No. | seeds* (0° C.) after 1 week | (0° C.) after 1 week |
| 1 | Clear | Clear |
| 2 | Clear | Clear |

*Both crystals of prothioconazole and Fluxapyroxad were used as seeding crystals.

Cold stability tests are aimed to observe the sensitivity of liquid formulations to storage at cold temperatures.

The effect of low temperatures on stability was determined and reported according to the Collaborative International Pesticide Analytical Council (CIPAC) method MT 39.3 (liquid formulations).

The SOP (standard operating procedure) describes several tests which involves exposure of the product to cold environments, in the cold stability test the samples are maintained at 0° C. and −10° C. which allows to observe the occurrence of crystal growth with or without seeding in specific time intervals.

### Procedure:

Two samples of formulation A were placed in a clear glass vails.
Sample 1 included 30 ml of formulation A and seeds of prothioconazole and fluxapyroxad.
The seeding of the crystals of the active ingredients was done 1 day after incubation.
Sample 2 included 30 ml of formulation A.
Samples 1 was kept for 1 week at 0° C. and tested for growth of crystals.
Sample 2 was kept for 1 week at 0° C. and at −10° C. and tested for appearance of crystals, sedimentation or freezing of the bulk.

### Observations:

In both samples (1 and 2) formation of crystals was not observed at 0° C.

In sample 2 sedimentation or freezing of the bulk was not observed at −10° C.

### Conclusions:

Cold temperatures may impact physical properties of certain formulation types including emulsion concentrates due to crystallization of the active ingredient(s) or separation of multi-phase systems.

It is clearly shown from the cold temperature tests (table 2) that formulation A gave a stable formulation without crystal growth of fluxapyroxad and prothioconazole.

TABLE 3
Emulsion stability test of formulation A

| | After 14 | |
|---|---|---|
| Emulsion stability | days | After 14 days |
| test** | (r.t*) | (54° C.) |
| Sample \| 1.25% | 0.03 ml | 0.01 ml |
| (“D” water) after | | |
| 2 hr | | |
| Sample \| 1.25% | 0.05 ml | 0.04 ml |
| (“D” water) after | | |
| 24 hr | | |
| Sample II 0.25% | 0 ml | 0.021 ml |
| (“D” water) after | | |
| 2 hr | | |
| Sample II 0.25% | 0.03 ml | 0.04 ml |
| (“D” water) after | | |
| 24 hr | | |

*r.t (room temperature) about 25 ± 5° C.
**Accuracy of ± 0.05 ml.

Formulation A was placed at room temp and in accelerate stability test at 54° C. for 14 days.

Emulsions were prepared in two field rate concentrations (0.25% and 1.25%) and were checked for emulsion stability according to CIPAC method after 2 and 24 hours.

Sample I 1.25%-1.25 ml of formulation A and 98.75 of water.

Sample II 0.25%-0.25 ml of formulation A and 99.75 of water.

### Procedure:

95 ml of standard water in room temperature (25±5° C.) were added to a measuring cylinder.
0.25 ml and 1.25 ml of formulation A were added to the measuring cylinder.
Water was added to the measuring cylinder up to 100 ml.
The cylinder was invert it once and after 30 sec good emulsion was obtained.
The cylinder was inverted additional 10 times, while each inversion implies turning the cylinder by hand through 180 degrees and returning it to the initial position; about 2 sec for each double inversion.

The analysis was performed after 2 and 24 hours from the emulsification step (addition of water).

### Conclusions:

It shows from table 3 that no creaming and/or sedimentation were observed either at the top or the bottom of the emulsion after 2 and 24 hours.

TABLE 4
Foaming test for formulation A

| | | Dilution with water | Dilution with water |
|---|---|---|---|
| | Dilution with water | 14 days after | 14 days after |
| | after preparation of | preparation of | preparation of |
| Foaming test | formulation A | formulation A (r.t)* | formulation A (54° C.) |
| Sample III 1.25% (“D” | 40 ml | 30 ml | 30 ml |
| water) | | | |
| Sample III 0.25% (“D” | 25 ml | 20 ml | 25 ml |
| water) | | | |

*r.t (room temperature) about 25 ± 5° C.

Persistent foaming test is used to determine the foam created once the formulation is diluted.

Formulation A was diluted in a measuring cylinder of standard dimensions which was inverted 30 times. The amount of persistent foam created and remaining after certain amount of time was measured.

### Procedure:

At room temperature (25±5° C.) two amounts of 180 ml of CIPAC standard water D were added into two separate 250 ml measuring cylinders standing on a top pan balance.
0.5 ml and 2.5 ml of formulation A were added into the two 250 ml measuring cylinders.
CIPAC standard water D was added into the two 250 ml measuring cylinders up to 200 ml.
The cylinders were inverted the 30 times (up to 180° and back for approximately 2 seconds each time), placed upright and the measurement took place exactly after 12 minutes.

### Conclusions:

It is clear from table 4 that the formulation A has low foaming level.

TABLE 5
Concentration of the actives in formulation A

| | | 11 days after | 14 days after | 11 days after | 14 days after |
|---|---|---|---|---|---|
| | | EC | EC | EC | EC |
| Concentration | After EC | preparation | preparation | preparation | preparation |
| (g/l) | preparation | (r.t) | (r.t) | (54° C.) | (54° C.) |
| Fluxapyroxad | 7.5 | 7.5 | 7.4 | 7.5 | 7.5 |
| Prothioconazole | 15.2 | 15.1 | 14.8 | 14.9 | 14.7 |

### Procedure:

The assay of the two Ai's was checked by HPLC Method.

The analytical method included:
1. Preparation of standard solution.
2. Sample solution preparation: 200 mg sample was measured in triplicates into 50 ml volumetric flask.
3. Acetonitrile was added.
4. Injection of the standard and sample solutions in room temperature.

The concentration was calculated by:

$$\% AI = \frac{AREA samp1e \times Weight standard \times Potency standard}{Area standard \times Weight sample}$$

The samples were checked for assay after 11 days and 14 days at room temperature and at 54° C. The AI % should not decrease more than 5% after the accelerated stability at 54° C.

### Conclusions:

Formulation A is stable and shows that the concentration of the active ingredients has low degradation after 14 days at 54° C. in oven. It also shows low foaming after the addition of water (emulsification step). Moreover, crystal growth was not observed in cold conditions (EC) and when emulsified in water.

### Example 2

TABLE 6
Formulation B

| Ingredient | Chemical Name | w/w |
|---|---|---|
| Fluxapyroxad | 3-(difluoromethyl)-1-methyl-N-(3′,4′,5′- | 9.06 |
| tech | trifluorobiphenyl-2-yl)pyrazole-4- | |
| | carboxamide | |
| Prothioconazole | 2-[(2RS)-2-(1-chlorocyclopropyl)-3-(2- | 15.31 |
| tech | chlorophenyl)-2-hydroxypropyl]-2H- | |
| | 1,2,4-triazole-3(4H)-thione | |
| Agsolex 8 | (A) 1-octylpyrrolidine-2-one, (B) | 12.2 |
| | Octylamine, (C) Dioctylamine, (D) | |
| | gama-Butyrolactone | |
| Genapol x 080 | Alcohols, C11-14-iso-, C13-rich, | 15.0 |
| | ethoxylated | |
| Soprophor 3 D | (A) 2,4,6-Tris(1- | 6.0 |
| 33 | phenylethyl)polyoxyethylenated | |
| | phosphates, (B)Poly(oxy-1,2- | |
| | ethanediyl), .alpha.-[tris(1- | |
| | phenylethyl)phenyl]-.omega.-hydroxy-, | |
| | (C)orthophosphoric acid | |
| | (POLYARYLPHENYL | |
| | ETHER PHOSPHATE) | |
| Soprophor BSU | Poly(oxy-1,2-ethanediyl), .alpha.-[tris(1- | 6.0 |
| | phenylethyl)phenyl]-.omega.-hydroxy | |
| Acetophenone | Acetophenone | 36.43 |

### Preparation Procedure:

Acetophenone and Agsolex 8 were charged into the reaction vessel and were heated to 35° C.

Fluxapyroxad and Prothioconazole were added and mixed until homogeneous solution was obtained.

Genapol X80, Soprophor 3D33 and Soprophor BSU were added and mixed until homogeneous solution was obtained which than cooled to room temperature (25° C.±5° C.).

The solution was filtered through 8 μm filter paper (Grade 40).

TABLE 7
Emulsion stability of formulation B

| Formulation B | |
|---|---|
| after 30 min from | Emulsion stability |
| preparation | test** |
| Sample IV 2 h | 0.05 ml |
| 1.75% (“D” | |
| water) | |
| Sample IV 24 h | 0.15 ml |
| 1.75% (“D” water) | |

r.t (room temperature) about 25 ± 5° C. ° C.
**Accuracy of the measurement ± 0.05 ml.

Formulation B was placed at room temp for 30 minutes.

Emulsion of formulation B was prepared in field rate concentration of 1.75% and was checked for emulsion stability according to CIPAC method after 2 and 24 hours.

Sample IV 1.75%-1.75 ml of formulation B and 98.25 of water.

### Procedure:

95 ml of standard water in room temperature (25±5° C.) were added to a measuring cylinder.
1.75 ml of formulation B was added to the measuring cylinder.
Water was added to the measuring cylinder up to 100 ml.
The cylinder was invert it once and after 30 sec good emulsion was obtained.
The cylinder was inverted additional 10 times, while each inversion implies turning the cylinder by hand through 180 degrees and returning it to the initial position; about 2 sec for each double inversion.

The analysis was performed after 2 and 24 hours from the emulsification step (addition of water).

TABLE 8
Foaming test of formulation B

| Formulation B after | |
|---|---|
| dilution with water | Foaming test |
| Foaming (1.75% “D” | 45 |
| water) (ml) | |
| Foaming (0.35% “D” | 33 |
| water) (ml) | |

Formulation B was diluted in a measuring cylinder of standard dimensions which was inverted 30 times. The amount of persistent foam created and remaining after certain amount of time was measured.

### Procedure:

At room temperature (25±5° C.) 180 ml of CIPAC standard water D was added into 250 ml measuring cylinder standing on a top pan balance.
3.5 ml of formulation B was added into the 250 ml measuring cylinder.
CIPAC standard water D was added into the 250 ml measuring cylinder up to 200 ml.
The cylinder was inverted 30 times (up to 180° and back for approximately 2 seconds each time), placed upright and the measurement took place exactly after 12 minutes.

TABLE 9
Concentration of the actives in formulation B

| | Formulation B after | Formulation B after | Formulation B after |
|---|---|---|---|
| Concentration (g/l) | EC preparation | 14 days (r.t) | 14 days (54° C.) |
| Prothioconazole | 15.3 | 14.5 | 14.7 |
| Fluxapyroxad | 8.9 | 8.8 | 9 |

### Procedure:

The assay of the two Ai's was checked by HPLC Method.

The analytical method included:
1. Preparation of standard solution.
2. Sample solution preparation: 200 mg sample was measured in triplicates into 50 ml volumetric flask.
3. Acetonitrile was added.
4. Injection of the standard and sample solutions in room temperature.

The concentration was calculated by:

$$\% AI = \frac{AREA samp1e \times Weight standard \times Potency standard}{Area standard \times Weight sample}$$

The samples were checked for assay after 11 days and 14 days at room temperature and at 54° C.

The AI % should not decrease more than 5% after the accelerated stability at 54° C.

TABLE 10
Formulation C

| Ingredient | Chemical Name | w/w |
|---|---|---|
| Fluxapyroxad | 3-(difluoromethyl)-1-methyl-N-(3′,4′,5′- | 9.06 |
| tech | trifluorobiphenyl-2-yl)pyrazole-4- | |
| | carboxamide | |
| Prothioconazole | 2-[(2RS)-2-(1-chlorocyclopropyl)-3-(2- | 15.31 |
| tech | chlorophenyl)-2-hydroxypropyl]-2H- | |
| | 1,2,4-triazole-3(4H)-thione | |
| Agsolex 8 | (A) 1-octylpyrrolidine-2-one, (B) | 12.2 |
| | Octylamine, (C) Dioctylamine, (D) gama- | |
| | Butyrolactone | |
| Synergen SOC | C10/C12 fatty alcohol-3-8 EO-3-8 PO & | 15.0 |
| | C16/C18 fatty alcohol-5-10 EO-4-9 PO + | |
| | blend of fatty acid esters | |
| Witconol NS- | non-ionic, EO-PO block butyl ether | 6.0 |
| 500LQ | | |
| Soprophor BSU | Poly(oxy-1,2-ethanediyl), .alpha.-[tris(1- | 6.0 |
| | phenylethyl)phenyl]-.omega.-hydroxy | |
| Acetophenone | Acetophenone | 36.43 |

### Preparation Procedure:

Acetophenone and Agsolex 8 were charged into the reaction vessel and were heated to 35° C.

Fluxapyroxad and Prothioconazole were added and mixed until homogeneous solution was obtained.

Synergen SOC, Witconol NS-500LQ and Soprophor BSU were added and mixed until homogeneous solution was obtained which than cooled to room temperature (25° C.±5° C.).

The solution was filtered through 8 μm filter paper (Grade 40).

TABLE 11
Emulsion stability of formulation C

| Formulation C | |
|---|---|
| after 30 min from | Emulsion stability |
| preparation | test** |
| Sample V 2 h | 0.4 ml |
| 1.75% (“D” | |
| water) | |
| Sample V 24 h | 3 ml |
| 1.75% (“D” water) | |

r.t (room temperature) about 25 ± 5° C. ° C.
**Accuracy of ± 0.05 ml.

Formulation C was placed at room temp for 30 minutes.

Emulsion of formulation C was prepared in field rate concentration of 1.75% and was checked for emulsion stability according to CIPAC method after 2 and 24 hours.

Sample V 1.75%-1.75 ml of formulation C and 98.25 of water.

### Procedure:

95 ml of standard water in room temperature (25±5° C.) were added to a measuring cylinder.
1.75 ml of formulation C was added to the measuring cylinder.
Water was added to the measuring cylinder up to 100 ml.
The cylinder was invert it once and after 30 sec good emulsion was obtained.
The cylinder was inverted additional 10 times, while each inversion implies turning the cylinder by hand through 180 degrees and returning it to the initial position; about 2 sec for each double inversion.

The analysis was preformed after 2 and 24 hours from the emulsification step (addition of water).

### Conclusions:

It shows from table 11 that sedimentation was observed on the bottom of the emulsion after 2 and 24 hours (emulsion test of formulation C), while in table 7 no creaming and/or sedimentation were observed either at the top or at the bottom of the emulsion after 2 and 24 hours (emulsion test of formulation B).

1. An agrochemical emulsion concentrate composition comprising:
a) at least one SDHI fungicide;
b) a carbonyl containing solvent; and
c) an adjuvant of formula (I) 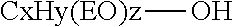
in which X is 6-13, Y is 14-28 and Z is 3-13.

2. The composition according to claim 1, wherein the at least one SDHI fungicide is selected from the group consisting of benodanil, flutolanil, mepronil, isofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, pydiflumetofen, pyraziflumid and any combination thereof.

3. The composition according to claim 2, wherein the at least one SDHI fungicide is fluxapyroxad.

4. The composition according to any one of claims 1-3, wherein the carbonyl containing solvent is selected from the groups of ketones, amides, ureas, esters, lactones, carbonates and any mixtures thereof.

5. The composition according to claim 4, wherein the ketone is selected from acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone, cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone, valerophenone and any mixtures thereof.

6. The composition according to claim 5, wherein the ketone is acetophenone.

7. The composition according to claim 4, wherein the amide is selected from N-formylmorpholine, N,N-dimethylformamide, N,N-dimethylacetamide, N,N-imethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, 1,3-dimethyl-2-imidazolidinone, 1,3,4-trimethyl-2-imidazolidinone, 1,3-dimethyl-3,4,5,6-tetrahydro-2(1H)pyrimidinone, 1-heptyl-3-methyl-2-imidazolidinone, 1-heptyl-1,3-dihydro-3-methyl-2H-imidazol2-one and any mixture thereof.

8. The composition according to claim 7, wherein the amide is selected from N,N-dimethyldecanamide, N,N-dimethyldecenamide, N,N-dimethyl-octanamide and any mixture thereof.

9. The composition according to any one of claims 1-8, wherein, in formula (I), X is 13; Y is 27 and Z is between 7 to 15.

10. The composition according to any one of claims 1-9, wherein the amount of the at least one SDHI fungicide is of about 1% to about 20% by weight, based on the total weight of the composition.

11. The composition according to claim 10, wherein the amount of fluxapyroxad is of about 1% to about 20% by weight, based on the total weight of the composition.

12. The composition according to any one of claims 1-11, wherein the at least one SDHI fungicide is in a concentration ranging from about 10 g/l to about 220 g/l of the composition.

13. The composition according to claim 12, wherein fluxapyroxad is in a concentration ranging from about 50 g/l to about 150 g/l of the composition.

14. The composition according to any one of claims 1-13, wherein the amount of the carbonyl containing solvent is of about 10% to about 60% by weight, based on the total weight of the composition.

15. The composition according to claim 14, wherein the amount of acetophenone is of about 10% to about 60% by weight, based on the total weight of the composition.

16. The composition according to any one of claims 1-15, wherein the amount of adjuvant of formula (I) is of about 1% to about 20% by weight, based on the total weight of the composition.

17. The composition according to any one of claims 1-16, wherein the ratio between the carbonyl containing solvent and the adjuvant of formula (I) is of about 60:1 to about 1:2.

18. The composition according to any one of claims 1-17, further comprising d) a triazole fungicide and e) N-alkyl pyrrolidone of formula (11): 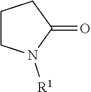
wherein R1 is a straight or branched, saturated or unsaturated, substituted or unsubstituted hydrocarbon group having from 4 to 10 carbon atoms.

19. The composition according to claim 18, wherein the triazole fungicide is selected from the group consisting of azaconazole, bitertanol, bromuconazole, cyproconazole, diclobutrazol, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, quinconazole, simeconazole, tetraconazole, triadimenol, triadimefon, triticonazole, uniconazole, uniconazole-P, voriconazole, prothioconazole, difenoconazole, propiconazole, tebuconazole, mefentrifluconazole and any mixture thereof.

20. The composition according to any one of claims 18-19, wherein the triazole fungicide is prothioconazole.

21. The composition according to any one of claims 18-20, wherein, in formula (II), R1 is a hydrocarbon group having from 7 to 9 carbon atoms.

22. The composition according to claim 21, wherein, in formula (II), R1 is a hydrocarbon group having 8 carbon atoms.

23. The composition according to any one of claims 18-22, wherein the ratio between the carbonyl containing solvent and the N-alkyl pyrrolidone of formula (II) is of about 30:1 to about 1:5.

24. The composition according to claim 23, wherein the ratio between the carbonyl containing solvent and the N-alkyl pyrrolidone of formula (I) is of about 25:1 to about 2:3.

25. The composition according to any one of claims 18-24, wherein the amount of the triazole fungicide is of about 0.5% to about 25% by weight, based on the total weight of the composition.

26. The composition according to claim 25, wherein the amount of prothioconazole is of about 0.5% to about 25% by weight, based on the total weight of the composition.

27. The composition according to any one of claims 18-26, wherein the amount of the N-alkyl pyrrolidone of formula (II) is of about 2% to about 50% by weight, based on the total weight of the composition.

28. The composition according to any one of claims 18-27, further comprising at least one mono-, di- or tristyryl phenol ethoxylate.

29. The composition according to claim 28, wherein the amount of the at least one mono-, di- or tristyryl phenol ethoxylate is of about 0.5% to about 20% by weight, based on the total weight of the composition.

30. The composition according to any one of claims 18-29, wherein the triazole fungicide is in a concentration ranging from about 30 g/l to about 250 g/l of the composition.

31. The composition according to claim 30, wherein prothioconazole is in a concentration ranging from about 30 to about 250 g/l of the composition.

32. A method for controlling and/or preventing pests comprising applying an effective amount of the composition according to any one of claims 1-31 to a locus where the pest is to be controlled and/or prevented so as to thereby control and/or prevent the pest.

33. The method of claim 32, wherein the pest is a phytopathogenic harmful fungi.

34. A method for controlling and/or preventing phytopathogenic harmful fungi comprising applying an effective amount of the composition according to any one of claims 1-31 to a locus where the phytopathogenic harmful fungi is to be controlled so as to thereby control the phytopathogenic harmful fungi.

35. The method according to any one of claims 32-34, wherein the locus is a crop field.

36. A method of controlling phytopathogenic harmful fungi in a field of crop comprising applying an effective amount of the composition according to any one of claims 1-31 to a field of crop so as to thereby control the phytopathogenic harmful fungi in the field of crop.

37. The method according to any one of claim 35 or 36, wherein the crop is selected from the group consisting of wheat, rye, rice, barley, oats, sorghum/millet, triticale, maize, rapeseed, beans, peanuts and sunflowers.

38. The method according to any one of claims 33-37, wherein the phytopathogenic harmful fungi is selected from Septoria species, Fusarium species, Puccinia species, Erisyphe species, Drechslera species, Ramularia species, Mycosphaerella species and Rhynchosporium species.

39. The method according to any one of claims 32-38, wherein the composition is applied in an amount from about 0.25 L/ha to about 2.0 L/ha.

40. Use of the composition according to any one of claims 1-31 for controlling and/or preventing pests.

41. Use of the composition according to any one of claims 1-31 for controlling and/or preventing harmful fungi.

42. Use of a combination of a carbonyl containing solvent and adjuvant of formula (I) 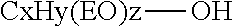
wherein X is 6-13, Y is 14-28, Z is 3-13 for increasing the efficacy of SDHI fungicides.

43. Use according to claim 42 wherein, the ratio between the carbonyl containing solvent and the adjuvant of formula (I) is of about 60:1 to about 1:2.

44. Use according to any one of claims 42-43, wherein the carbonyl containing solvent is acetophenone.

45. Use according to any one of claims 42-44 wherein, in formula (I), X is 13; Y is 27 and Z is between 7 to 15.

46. Use according to any one of claims 42-45, wherein the SDHI fungicide is fluxapyroxad.

47. Combination of a carbonyl containing solvent and adjuvant of formula (I) 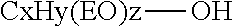
wherein X is 6-13, Y is 14-28, Z is 3-13 for increasing the efficacy of SDHI fungicides.

48. The combination according to claim 47 wherein, the ratio between the carbonyl containing solvent and the adjuvant of formula (I) is of about 60:1 to about 1:2.

49. The combination according to any one of claims 47-48 wherein, the carbonyl containing solvent is acetophenone.

50. The combination according to any one of claims 47-49 wherein, in formula (I), X is 13; Y is 27 and Z is between 7 to 15.

51. The combination according to any one of claims 47-50 wherein, the SDHI fungicide is fluxapyroxad.

52. A method of control of crystal growth of SDHI fungicide in agrochemical emulsion by addition of a) carbonyl containing solvent, b) N-alkyl pyrrolidone of formula (11): 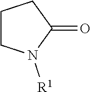
wherein R1 is a straight or branched, saturated or unsaturated, substituted or unsubstituted hydrocarbon group having from 4 to 10 carbon atoms and c) adjuvant of formula (I) 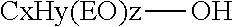
in which X is 6-13, Y is 14-28 and Z is 3-13.
